(19) United States
(12) Patent Application Publication
(10) Pub. No.: US 2012/0028484 A1
(43) Pub. Date: Feb. 2, 2012

(54) Automatic Sliding Door

(75) Inventors: Henry Chen, Arcadia, CA (US); Joseph Shien Tang Tseng, Diamond Bar, CA (US)

(73) Assignee: EVER WIN INTERNATIONAL CORPORATION, City of Industry, CA (US)

(21) Appl. No.: 12/848,393

(22) Filed: Aug. 2, 2010

(51) Int. Cl. H01R 13/44

(52) U.S. Cl. 439/136

(57) ABSTRACT

An automatic cover for universal serial bus (USB) port that opens and closes automatically when a USB plug is inserted and removed from the USB port. The automatic sliding door for a universal serial bus comprises a top door, a biasing means to urge the top door downward, a bottom door, a biasing means to urge the bottom door upward, and a support structure to which the top door and the bottom door are pivotally affixed. The top door and bottom door opens automatically upon insertion of a USB plug. When the USB plug is removed, the top door and bottom door closes automatically.

### BACKGROUND

1. Field of Invention

The present invention relates generally to a cover for a universal serial bus port. More specifically, the present invention relates to a cover that automatically opens and closes when a universal serial bus plug is inserted and removed from the universal serial bus port.

2. Description of Related Art

Universal serial bus (USB) is a specification created around 1996 to establish communication between electronic devices and a host controller. The host controller is usually a computer. USB can carry both power and data. It is intended to replace a variety of serial and parallel ports. USB is used to connect computer peripherals such as mice, keyboards, digital cameras, printers, flash drives, and external hard drives to a computer. It has become a common electronic interface for many modern electronic devices and computers.

The standard USB port has a rectangular opening with a plastic tongue that is enclosed in a metal sheath. There are four electrical contacts on the plastic tongue. The standard USB plug has a compatible plug that can only plug into the USB port in one orientation.

The opening of the USB port is exposed to the environment at all times. It is susceptible to collect dust and other contaminants. The opening of the USB port also exposes the electrical contacts within the USB port to being short circuited if a conductive material or a liquid, such as drops of water, accidentally enters the opening and bridges the electrical contacts. Furthermore, the opening of the USB port allows foreign objects to enter the USB port unintentionally, which may damage the USB port or the electrical contacts within it.

### BRIEF SUMMARY OF THE INVENTION

The present invention is an automatic cover for universal serial bus (USB) port that opens and closes automatically when a USB plug is inserted and removed from the USB port. The automatic sliding door comprises of a top door, a biasing means to urge the top door downward, a bottom door, a biasing means to urge the bottom door upward, and a support structure to which the top door and the bottom door are pivotally affixed. The top door and bottom door remain closed if the USB port is not being used. The top door and bottom door opens automatically upon insertion of a USB plug. When the USB plug is removed, the top door and bottom door automatically closes.

An object of the automatic sliding door is to provide a convenient cover for the USB port. A further object of the automatic sliding door is to provide a cover for the USB port that opens and closes automatically upon insertion and removal of a USB plug. An additional object of the automatic sliding door is to provide protection to the USB port. Another object of the automatic sliding door is to minimize entry of dust and other environment contaminants into the USB port.

### BRIEF DESCRIPTION OF THE DRAWINGS

FIG. 1 shows a perspective view of the preferred embodiment of the top door.

FIG. 2 shows the side view of the preferred embodiment of the top door.

FIG. 3 shows a plan view of the preferred embodiment of the top door.

FIG. 4 shows another plan view of the preferred embodiment of the top door.

FIG. 5 shows a top plan view of the preferred embodiment of the top door.

FIG. 6 shows a perspective view of the preferred embodiment of the bottom door.

FIG. 7 shows the side plan view of the preferred embodiment of the bottom door.

FIG. 8 shows a plan view of the preferred embodiment of the bottom door.

FIG. 9 shows the top plan view of the preferred embodiment of the bottom door.

FIG. 10 shows another plan view of the preferred embodiment of the bottom door.

FIG. 11 shows a perspective view of the preferred embodiment of the support structure.

FIG. 12 shows the bottom plan view of the preferred embodiment of the support structure.

FIG. 13 shows another perspective view of the preferred embodiment of the support structure.

FIG. 14 shows the rear plan view of the preferred embodiment of the support structure.

FIG. 15 shows the left side plan view of the preferred embodiment of the support structure.

FIG. 16 shows the front plan view of the preferred embodiment of the support structure.

FIG. 17 shows the right side plan view of the preferred embodiment of the support structure.

FIG. 18 shows the exploded perspective view of the automatic sliding door in a vehicle power adapter.

FIG. 19 shows a side plan view of the preferred embodiment of the automatic sliding door in a vehicle power adapter.

FIG. 20 shows the rear plan view of the preferred embodiment of the automatic sliding door in a vehicle power adapter.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

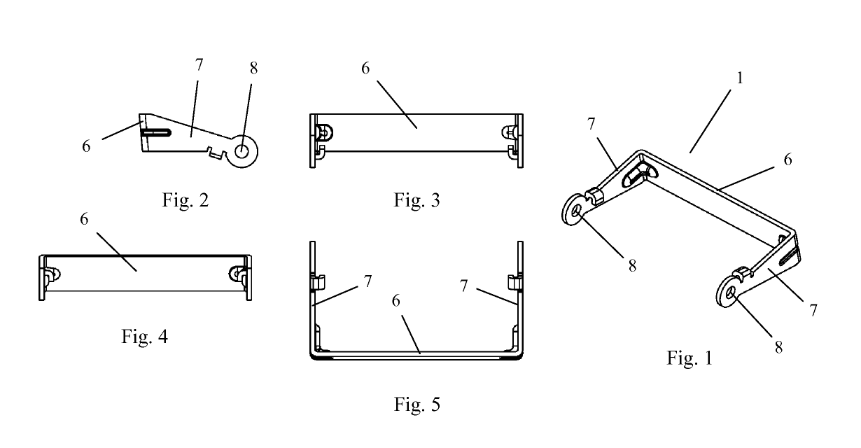

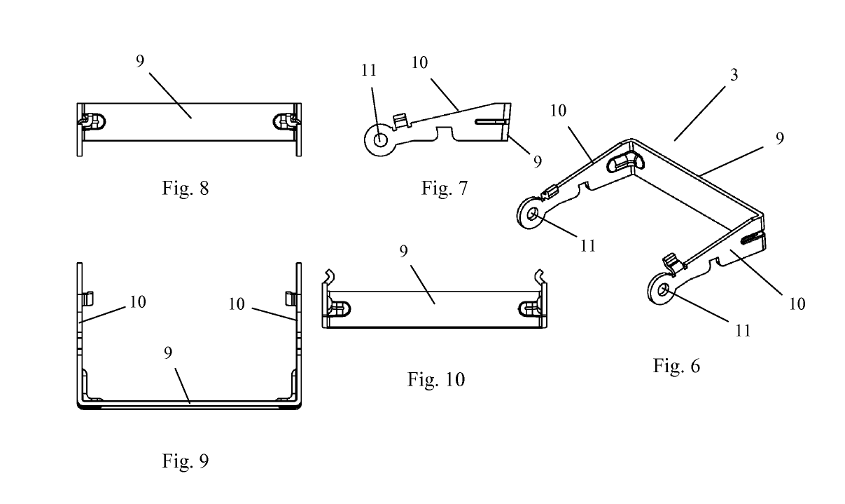

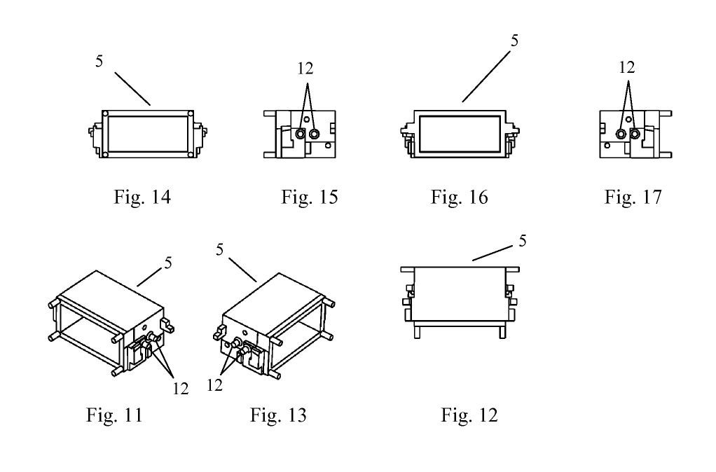

The preferred embodiment of the automatic sliding door comprises of a top door 1, a biasing means 2 to urge the top door 1 downward, a bottom door 3, a biasing means 4 to urge the bottom door 3 upward, and a support structure 5 to which the top door 1 and the bottom door 3 are pivotally affixed. FIGS. 1 through 5 show various views of the preferred embodiment of the top door 1. The top door 1 is generally an elongated sheet metal with a straight door-section 6 and two pivot arms 7 that are bent at approximately right angle to the door-section 6. At the end of each of the two pivot arm 7 is a pivot hole 8 for pivotally attaching the top door 1 to the support structure 5.

FIGS. 6 through 10 show various views of the preferred embodiment of the bottom door 3. The bottom door 3 is generally an elongated sheet metal with a straight door-section 9 and two pivot arms 10 that are bent at approximately right angle to the door-section 9. At the end of each of the two pivot arm 10 is a pivot hole 11 for pivotally attaching the bottom door 3 to the support structure 5.

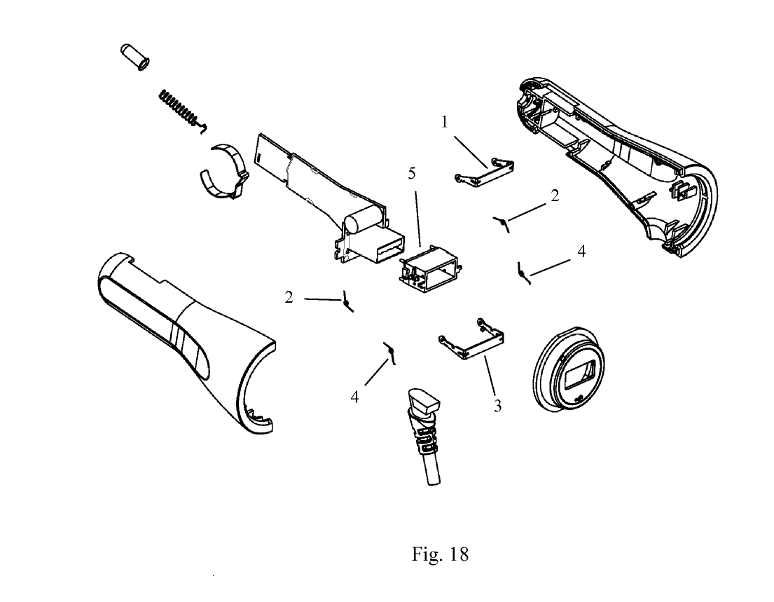

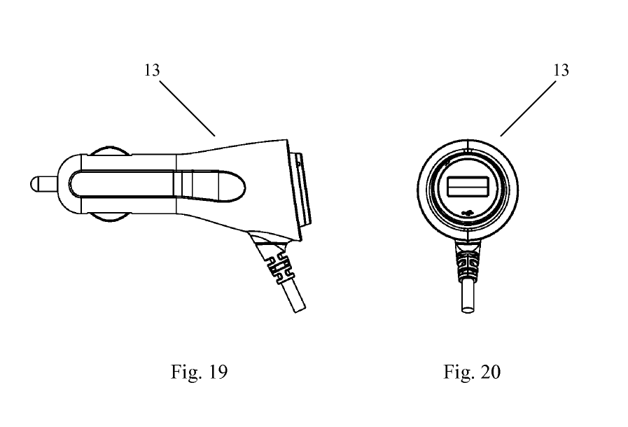

FIGS. 11 through 17 show various views of the preferred embodiment of the support structure 5. The support structure 5 is generally in the shape of a rectangular sleeve approximately the exterior dimension of a USB port. The support structure 5 has two open ends and affixes around the USB port. On both sides of the support structure 5 are pivot pins 12 for the pivotal attachments of the pivot arms 7, 10 of the top door 1 and bottom door 3. The pivot pins 12 insert into the pivot holes 8, 11 in the pivot arms 7, 10 of the top door 1 and bottom door 3. In the preferred embodiment, there are two pivot pins 12 on each side of the support structure 5, one for the top door pivot hole 8 and the other one for the bottom door pivot hole 11.

Biasing means 2, 4, preferably springs, are affixed to each pivot arm 7, 10 of the top door 1 and bottom door 3 urging the top door 1 downward and the bottom door 3 upward. Therefore, the biasing means 2, 4 keep the top door 1 and bottom door 3 in a normally closed position. In the closed position, the door-sections 6, 9 of the top door 1 and bottom door 3 are adjacent to each other and form a shallow angle between the two door-sections 6, 9. The top door 1 and bottom door 3 are urged to remain closed by the biasing means 2, 4 if the USB port is not being used. The top door 1 and bottom door 3 are forced open automatically upon insertion of a USB plug between them into the USB port. The shallow angle between the two door-sections 6, 9 of the top door 1 and bottom door 3 enables the doors to slide open in the opposite direction when the USB plug contacts the door-sections 6, 9. When the USB plug is removed, the top door 1 and bottom door 3 are automatically closed by the biasing means 2, 4.

In one embodiment, the automatic sliding door is affixed over the USB port of a vehicle power adapter 13 as shown in FIGS. 18, 19, and 20. The automatic sliding door may also be affixed over any suitable USB port to protect the USB port from dust and other contaminants. The automatic sliding door protects the electrical contacts within the USB port and prevents foreign objects to enter the USB port unintentionally.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. An automatic sliding door for a universal serial bus comprising:
a top door;
a first biasing means urging the top door downward;
a bottom door;
a second biasing means urging the bottom door upward; and
a support structure;
whereby said top door and said bottom door are pivotally affixed to the support structure.

2. An automatic sliding door for a universal serial bus as in claim 1 wherein said top door and said bottom door are made of a metallic material.

3. An automatic sliding door for a universal serial bus as in claim 1 wherein said first biasing means and said second biasing means are springs.

4. An automatic sliding door for a universal serial bus as in claim 1 wherein said support structure is generally in the shape of a rectangular sleeve approximately the exterior dimension of a USB port.

5. An automatic sliding door for a universal serial bus as in claim 1 wherein said top door and said bottom door meet at a shallow angle.

6. An automatic sliding door for a universal serial bus as in claim 1 wherein the automatic sliding door is affixed to a universal serial bus port of a vehicle power adapter.

7. An automatic sliding door for a universal serial bus comprising:
a top door comprising a first generally planer door-section with two ends and a pivot arm at each end of the first door-section;
a first biasing means urging the top door downward;
a bottom door comprising a second generally planer door-section with two ends and a pivot arm at each end of the second door-section;
a second biasing means urging the bottom door upward; and
a support structure;
whereby said top door and said bottom door are pivotally affixed to the support structure.

8. An automatic sliding door for a universal serial bus as in claim 7 wherein said top door and said bottom door are made of a metallic material.

9. An automatic sliding door for a universal serial bus as in claim 7 wherein said first biasing means and said second biasing means are springs.

10. An automatic sliding door for a universal serial bus as in claim 7 wherein said support structure is generally in the shape of a rectangular sleeve approximately the exterior dimension of a USB port.

11. An automatic sliding door for a universal serial bus as in claim 7 wherein said first door-section and said second door-section meet at a shallow angle.

12. An automatic sliding door for a universal serial bus as in claim 7 wherein the automatic sliding door is affixed to a universal serial bus port of a vehicle power adapter.
